(19) United States
(12) Patent Application Publication
(10) Pub. No.: US 2021/0279486 A1
(43) Pub. Date: Sep. 9, 2021

(54) COLLISION AVOIDANCE AND PEDESTRIAN DETECTION SYSTEMS

(71) Applicants: Vincent NGUYEN, Toronto (CA); Quang Van Truong NGUYEN, Toronto (CA)

(72) Inventors: Vincent NGUYEN, Toronto (CA); Quang Van Truong NGUYEN, Toronto (CA)

(21) Appl. No.: 16/812,907

(22) Filed: Mar. 9, 2020

(51) Int. Cl. G06K 9/00; B60W 50/14; B60K 35/00; G06T 7/73

(52) U.S. Cl. CPC G06K 9/00805; G06K 9/00369; B60W 50/14; B60K 35/00; G06T 2207/30196; B60W 2050/146; B60W 2554/4029; B60W 2300/10; B60W 2556/45; G06T 7/74

(57) ABSTRACT

A method for detecting pedestrians in a vicinity of a vehicle is disclosed. The method includes: receiving image data acquired using one or more cameras, the image data depicting at least a portion of the vehicle's surroundings and at least one human subject; determining image coordinates corresponding to one or more parts of a body of the at least one human subject that are detected in the image data; obtaining vehicle environment information for the vehicle, the vehicle environment information identifying a plurality of regions that are defined in an area surrounding the vehicle; determining that the at least one human subject is present within a first one of the plurality of regions based on the image coordinates corresponding to the one or more detected body parts; and generating a notification indicating the detected presence of the at least one human subject in the first region.

### TECHNICAL FIELD

The present disclosure relates to car safety systems and, in particular, to systems and methods for collision avoidance and pedestrian detection.

### BACKGROUND

For car drivers, accurate and timely detection of pedestrians is crucial for avoiding collisions. A pedestrian detection system for a vehicle can alert the driver of the presence of persons near the vehicle and/or cause the vehicle to engage measures (e.g. emergency braking, speed reduction, etc.) in response to the detection.

Large vehicles, such as trucks and buses, present various challenges to detecting pedestrians. Even with the assistance of mirrors placed around a vehicle, the driver may not be able to see all areas of the vehicle's environment promptly or with clarity. The challenges are compounded in the case of school buses, which usually carry children and teenagers. As the passengers are generally of smaller stature, school bus drivers may have great difficulty in recognizing the presence of passengers in the vicinity of the vehicle (e.g. before loading or after unloading passengers). Younger children may be less attentive and vigilant about dangerous driving scenarios, which further increase the risk of injuries or fatalities involving school buses.

### BRIEF DESCRIPTION OF DRAWINGS

Reference will now be made, by way of example, to the accompanying drawings which show example embodiments of the present application and in which:

FIG. 1 is a block diagram of an example pedestrian detection system for a vehicle, in accordance with example embodiments of the present disclosure;

FIGS. 2A and 2B illustrate possible positions and orientations of cameras for mounting on a vehicle, in accordance with example embodiments of the present disclosure;

FIGS. 3A and 3B illustrate areas representing danger regions for pedestrians in the vicinity of a vehicle;

FIGS. 4A to 4F diagrammatically illustrate an example classification of detection scenarios at a side of a vehicle, in accordance with example embodiments of the present disclosure;

FIG. 5 diagrammatically illustrate an example classification of detection scenarios at the front of a vehicle, in accordance with example embodiments of the present disclosure;

FIG. 6 shows bird's eye views of a vehicle and representations of regions surrounding the vehicle, in accordance with example embodiments of the present disclosure; and

FIG. 7 shows, in flowchart form, an example method for detecting the presence of human subjects in the vicinity of a vehicle;

FIG. 8 shows, in flowchart form, another example method for detecting the presence of human subjects in the vicinity of a vehicle;

FIGS. 9A and 9B illustrate an example graphical user interface for displaying pedestrian detection information, in accordance with example embodiments of the present disclosure.

### Like reference numerals are used in the drawings to denote like elements and features.

### DETAILED DESCRIPTION OF EXAMPLE EMBODIMENTS

In an aspect, the present disclosure describes a pedestrian detection system for a vehicle. The system includes a memory, one or more cameras for capturing images of the vehicle's surroundings, the cameras being mountable on the vehicle. The system also includes a processor coupled to the memory and the one or more cameras. The processor is configured to: receive image data acquired using the one or more cameras, the image data depicting at least a portion of the vehicle's surroundings and at least one human subject; determine image coordinates corresponding to one or more parts of a body of the at least one human subject that are detected in the image data; obtain vehicle environment information for the vehicle, the vehicle environment information identifying a plurality of regions that are defined in an area surrounding the vehicle; determine that the at least one human subject is present within a first one of the plurality of regions based on the image coordinates corresponding to the one or more detected body parts; and generate a notification indicating the detected presence of the at least one human subject in the first region.

In some implementations, the image data may comprise a plurality of image frames and wherein the image coordinates comprise coordinates within an image frame.

In some implementations, determining that the at least one human subject is present within the first region may comprise: determining a position of the at least one human subject relative to the vehicle based on the image coordinates corresponding to the one or more detected body parts and orientations of the one or more cameras; and determining that the at least one human subject is present within the first region based on the position of the at least one human subject relative to the vehicle.

In some implementations, determining that the at least one human subject is present within the first region may comprise comparing the image coordinates corresponding to the one or more detected body parts to image coordinates associated with the first region in the image data.

In some implementations, determining that the at least one human subject is present within the first region may comprise determining that the image coordinates corresponding to the one or more detected body parts include at least the image coordinates for a first subset of body parts.

In some implementations, generating the notification may comprise generating a graphical representation of an alert for displaying on a display device associated with the vehicle.

In some implementations, generating the notification may comprise: determining at least one of a gear shift position of the vehicle or a door open status of the vehicle; and selecting a notification based on the at least one of a gear shift position of the vehicle or a door open status of the vehicle.

In some implementations, the processor may be further configured to generate a visual representation of at least one of the plurality of regions for displaying on a display device associated with the vehicle.

In some implementations, the processor may be further configured to provide an indication of the presence of the at least one human subject in the visual representation of the at least one of the plurality of regions.

In some implementations, the processor may be further configured to cause a braking system associated with the vehicle to be activated in response to determining that the at least one human subject is present in the first region.

In another aspect, the present disclosure describes a method for detecting pedestrians in a vicinity of a vehicle. The method includes: receiving image data acquired using one or more cameras, the image data depicting at least a portion of the vehicle's surroundings and at least one human subject; determining image coordinates corresponding to one or more parts of a body of the at least one human subject that are detected in the image data; obtaining vehicle environment information for the vehicle, the vehicle environment information identifying a plurality of regions that are defined in an area surrounding the vehicle; determining that the at least one human subject is present within a first one of the plurality of regions based on the image coordinates corresponding to the one or more detected body parts; and generating a notification indicating the detected presence of the at least one human subject in the first region.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “presence information” for a vehicle refers to information describing the presence of human (or non-human) subjects in a defined area or region around the vehicle. For example, presence information may include a binary indication of presence (i.e. occupied or non-occupied) in an area, a specific location within an area that is occupied by the subject, time and duration of the subject's occupation of the area, and motion orientation and status (e.g. moving or stationary) of the subject.

The present disclosure describes a car safety system for large vehicles, such as school buses. Specifically, the present disclosure provides a video-based collision avoidance and pedestrian detection system which may be implemented in a vehicle to enhance driving safety. The system employs a plurality of cameras that are mounted on a vehicle to acquire image and/or video data depicting the vehicle's surroundings, and the acquired data is analyzed to detect the presence of human subjects in the vicinity of the vehicle. The system analyzes image/video data to identify coordinates which correspond to parts of the body of human subjects, and uses this information to determine whether there are pedestrians occupying one or more predefined regions in the area surrounding a vehicle. The technology disclosed herein may be deployed on various different types of vehicles, to facilitate detection of dangerous driving scenarios (e.g. collisions) and conditions.

The present disclosure also provides systems and methods for notifying a driver of the presence of human subjects around a vehicle. If the disclosed system detects, based on analysis of image/video data, that pedestrians are present in the vicinity of a vehicle, the system may provide alerts for the driver in response to the detection. In at least some embodiments, the alerts may be internal to the vehicle. The alerts may, for example, be visual alerts that are presented on a display interface visible to the driver, or auditory alerts that are output via onboard speakers. Additionally, the alerts may be external to the vehicle, such that persons outside of the vehicle can be notified. Various different alerts may be generated, depending on the particular scenarios or conditions that are detected by the system.

The present disclosure also describes graphical user interfaces for displaying pedestrian detection data. A vehicle may be equipped with one or more display devices which provide a graphical user interface (GUI) for displaying various safety-related information, including pedestrian detection information indicating the presence of human subjects in areas around the vehicle. The GUI may provide graphical representations of the vehicle and the location of human subjects relative to the vehicle (e.g. in front of the vehicle, proximal to a side of the vehicle, partially underneath the vehicle, etc.). In some embodiments, the GUI may display real-time video feeds from one or more of the cameras mounted on the vehicle, showing at least portions of the vehicle's surrounding environment. The GUI may be updated in real-time to provide up-to-date information relating to, among others, operation of the vehicle, location and current route of the vehicle, nearby pedestrian detection, and current environmental conditions for the vehicle.

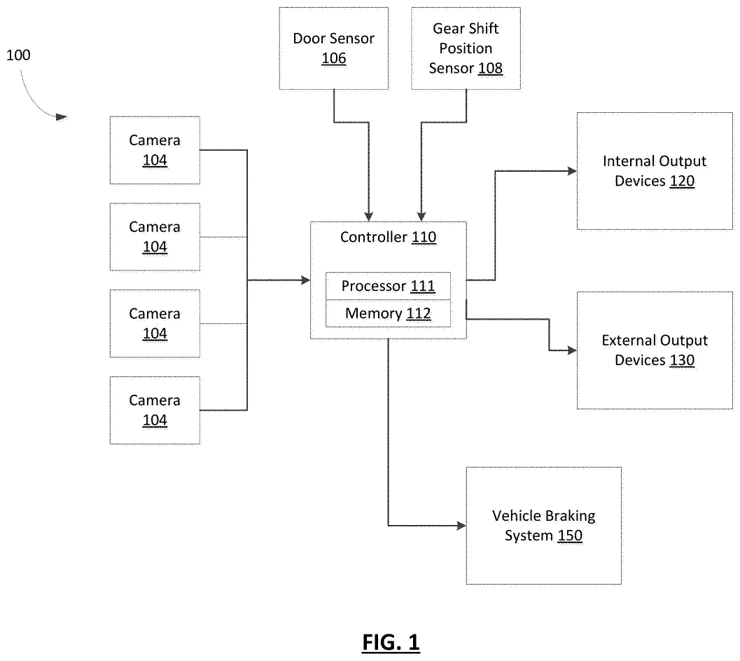

Reference is made to FIG. 1, which shows a block diagram of an example pedestrian detection system 100 for a vehicle 101 (not shown in FIG. 1). The pedestrian detection system 100 may be used in monitoring the vehicle's immediate surroundings, such as an area around the vehicle 101, to detect the presence of human subjects. In some embodiments, the pedestrian detection system 100 may be integrated into or operated in conjunction with a driver assistance system for the vehicle 101. In particular, the pedestrian detection system 100 may provide presence information which may be used, for example by a driver assistance system, in alerting a driver of dangerous (or potentially dangerous) driving scenarios and conditions involving nearby pedestrians. The pedestrian detection system 100 is designed to determine presence information both when the vehicle 101 is in motion and when the vehicle 101 is stationary (e.g. parked or stopped).

The pedestrian detection system 100 includes one or more cameras 104. The cameras 104 are capable of acquiring camera data such as images in the form of still photographs and/or motion video. The camera data may be captured in the form of an electronic signal which is produced by an image sensor. The cameras 104 may be configured to acquire image data, captured at select regular intervals, as well as continuous video data.

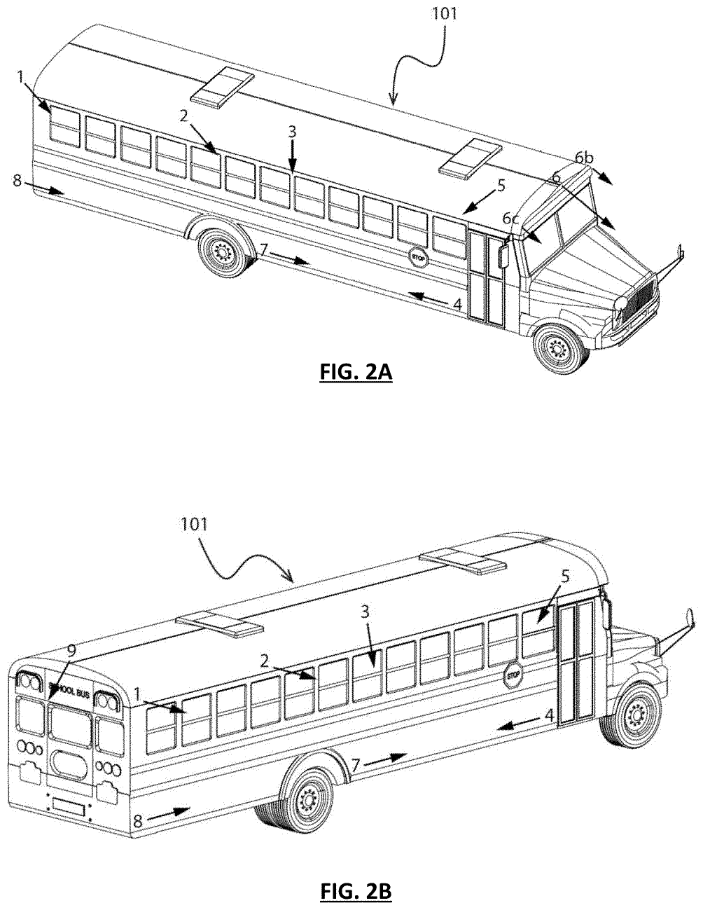

The cameras 104 are mounted at one or more locations on the exterior of the vehicle 101. FIGS. 2A and 2B illustrate example locations and orientations of cameras which may be mounted on the vehicle 101. The cameras 104 on the exterior of the vehicle 101 are positioned to facilitate capturing image data depicting areas surrounding the vehicle 101. Specifically, the cameras 104 are positioned such that the field of view of at least some of the cameras 104 include ground regions, such as floors, roads, sidewalks, etc., around the vehicle 101 that are accessible by human (or non-human) subjects. In some embodiments, the cameras 104 may include one or more primary cameras and one or more secondary cameras. As shown in FIGS. 2A and 2B, the primary cameras (3, 4, 6, 8 and 9) may be positioned on the exterior of the vehicle 101 such that at least one primary camera 9 is directed towards the rear of the vehicle 101, at least one primary camera 6 is directed towards the front of the vehicle 101, and at least one primary camera 3 is directed towards each side of the vehicle 101. Additional cameras, or secondary cameras (1, 2, 5, and 7), may be installed for imaging the side of the vehicle 101. The secondary cameras may provide supplementary image data which can be combined with image data from the primary cameras to obtain more details of the areas, including the ground regions (e.g. near the vehicle's wheels), to the immediate left and right sides of the vehicle 101. In some embodiments, one or more secondary cameras (such as cameras 6b and 6c) may be installed near the front of the vehicle 101 to capture supplementary image data depicting the area directly in front of the vehicle 101.

In at least some embodiments, the pedestrian detection system 100 may be connected to a network 14 (not shown in FIG. 1). For example, one or more of the cameras 104 may be configured to connect wirelessly to a network 14. The network 14 may include one or more wired or wireless communication networks, or combinations of both. For example, the network 14 may include a wireless wide area network (WWAN), or a wireless local area network (WLAN) that conforms to the IEEE 802.11 standards (sometimes referred to as Wi-Fi). The network 14 may, in some embodiments, be an Internet Protocol (IP)-based network.

The pedestrian detection system 100 also includes at least one controller 110. The controller 110 is configured to obtain image data from the cameras 104 and analyze those images in real-time. The controller 110 may include a processor 111, a memory 112, and a communications subsystem. The processor 111 may include a single processor with multiple cores or multiple processors (with single or multiple cores). The processor 111 may operate under stored program control and execute one or more software modules store in the memory (e.g. flash memory) 112. The memory 112 may store data that is collected via various sensors associated with the vehicle 101. For example, sensor data from at least one of the cameras 104, a door sensor 106, and a gear shift position sensor 108 may be stored in the memory 112.

In at least some embodiments, the memory 112 may store vehicle-specific data which is used in determining presence information for the vehicle 101. As a particular example, the memory 112 may store information describing predefined areas or regions around the vehicle 101 that are deemed to be “danger” zones. These “danger” zones are areas around the vehicle 101 that are difficult for a driver to observe directly or indirectly (e.g. using mirrors). A vehicle's blind spots may, for example, be identified as danger zones. The memory 112 may store details, such as relative location, shape, and dimensions of one or more predefined danger zones for the vehicle 101. In some embodiments, the memory 112 may store image data depicting the danger zones without any human subjects present in those zones. In particular, reference images which depict at least parts of the danger zones around the vehicle 101 may be stored in memory 112.

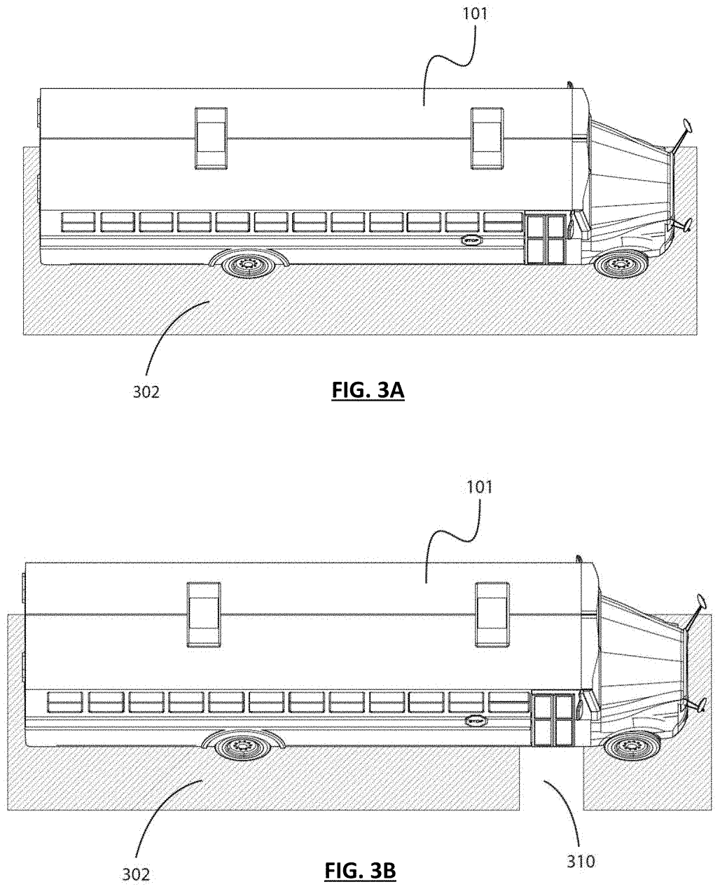

FIGS. 3A and 3B illustrate an example area 302 which represents a danger zone for the vehicle 101. Specifically, the area 302 is a three-dimensional space immediately surrounding the vehicle 101. As shown in FIGS. 3A and 3B, the area 302 may have a generally rectangular shape, and encompasses space of predefined dimensions in front of, behind, and to both sides (i.e. left and right sides) of the vehicle 101. It may be difficult for a driver of the vehicle 101 to observe, either directly or indirectly, the area 302. In particular, the presence of pedestrians in the area 302 may represent a potential hazard, such as a collision. The pedestrian detection system 100 may be configured to determine presence information in connection with the area 302 and notify the driver and/or nearby persons accordingly.

FIG. 3B shows that the area 302 may be dynamically altered to reflect the space which represents a danger zone for the vehicle 101. For example, when the door of the vehicle 101 is opened, the region 310 may be excluded from the area 302, as the driver may be able to directly observe presence information for and any activities taking place in the region 310.

The pedestrian detection system 100 includes an alert mechanism for notifying the driver of the vehicle 101 or nearby pedestrians of dangerous or potentially dangerous driving scenarios and conditions. The alerts for the driver are provided internally within the vehicle 101. In particular, the pedestrian detection system 100 includes one or more internal output devices 120 for providing internal alerts of potential collision hazards. The internal output devices 120 may include, for example, speakers, display devices (e.g. touchscreen display), and indicator light sources (e.g. LED lamp or light bulb). Additionally, the pedestrian detection system 100 may include external output devices 130 for providing alerts that are external to the vehicle 101. For example, one or more speakers may be mounted to the vehicle's exterior. The speakers may be activated to alert nearby persons of potential hazards involving the vehicle 101. As will be described in greater detail below, the internal output devices 120 and/or the external output devices 130 may be selectively activated to generate predefined alerts in response to detection of pedestrians in the vicinity of the vehicle 101.

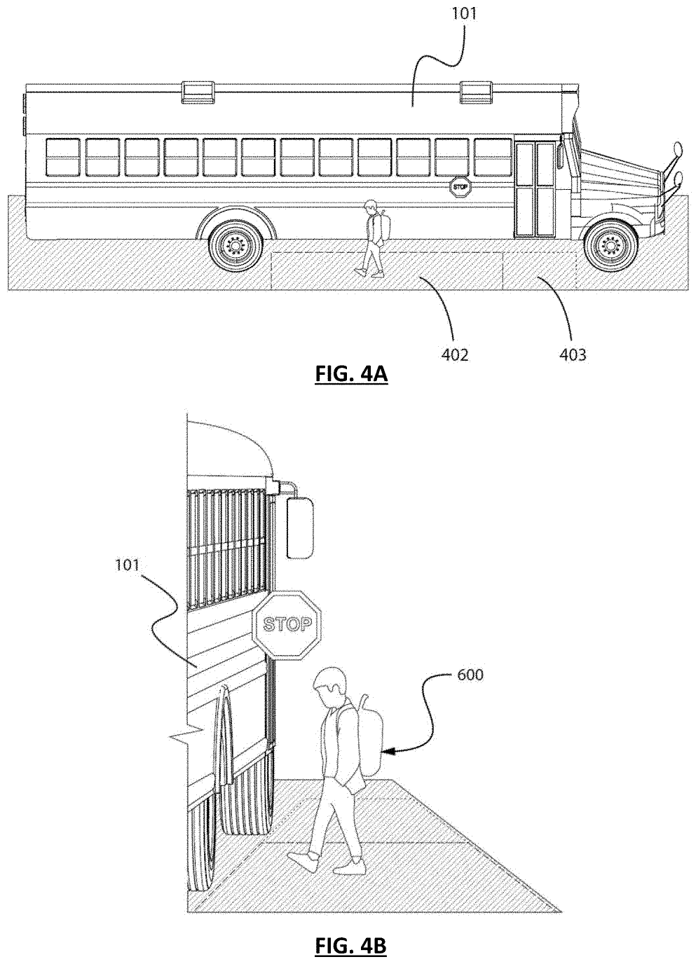

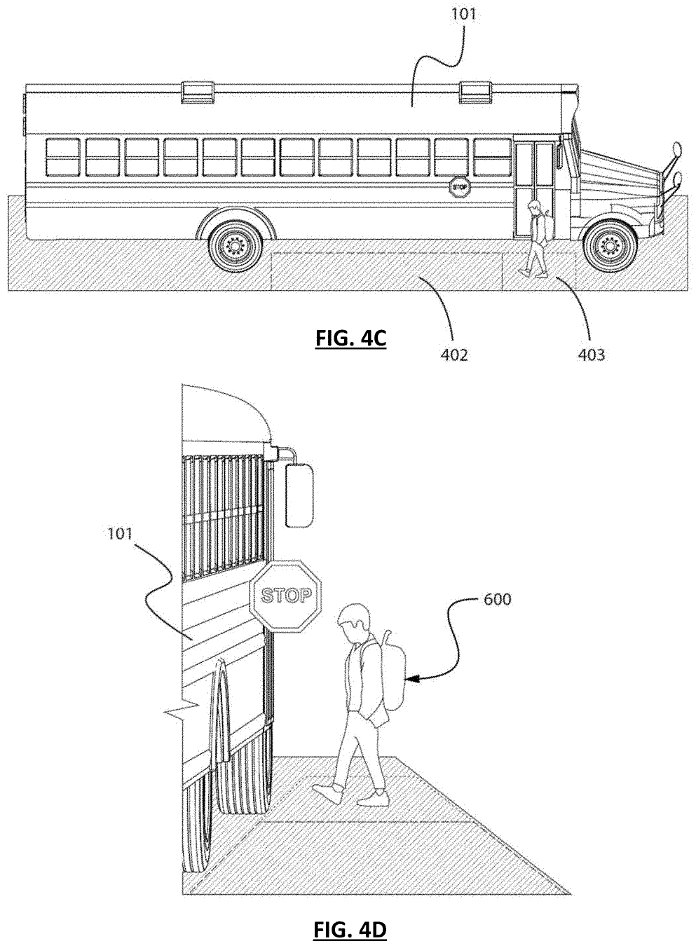

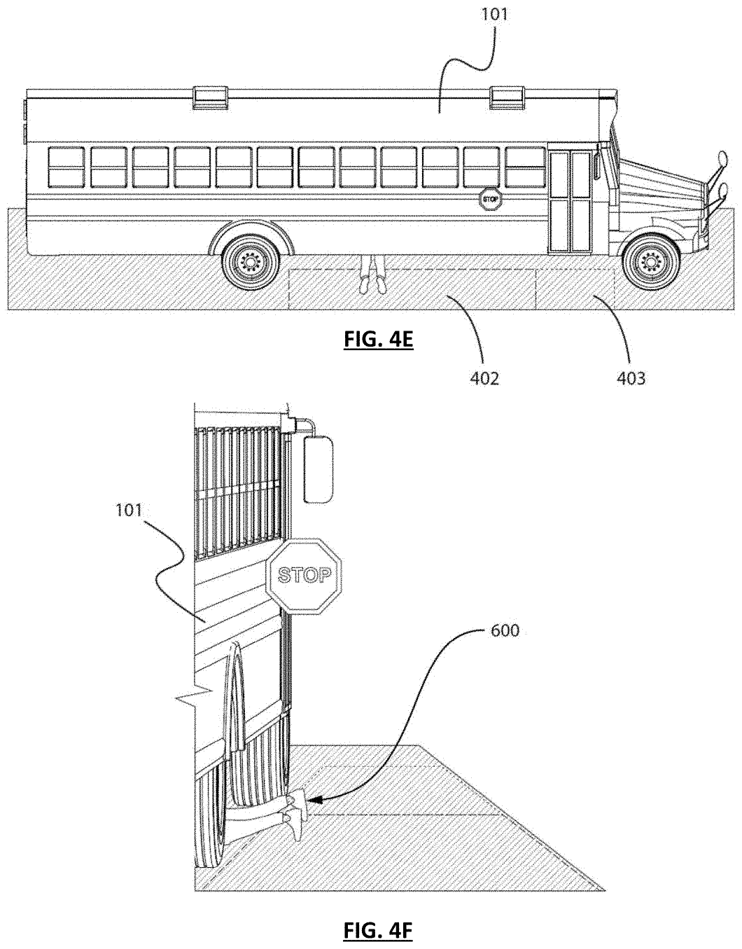

Reference is made to FIGS. 4A to 4F, which show an example classifications of presence information at a side of the vehicle 101. The pedestrian detection system 100 may define a plurality of regions in the area (such as area 302 of FIGS. 3A and 3B) surrounding the vehicle 101. In FIGS. 4A to 4F, the regions 402 and 403 are defined at a side of the vehicle 101. These regions may represent different degrees of potential danger for any pedestrian occupying the regions. Additionally, or alternatively, the regions may be associated with different degrees of visibility or observability for the driver. Thus, it is useful to classify the regions in the immediate vicinity of the vehicle 101 such that suitable actions (e.g. alerts) can be taken depending on the region in which presence of human subjects is detected.

By way of example, when a human subject is detected to be standing in region 402, a first alert may be generated for the driver. The first alert may be associated with a high degree of potential danger. By comparison, when a human subject is detected to be standing in region 403 a second alert that is associated with a lower degree of potential danger may be generated for the driver. The region 403 may, for example, be an area that is more easily observable by the driver. The first and second alerts may be visually and/or audibly distinct such that the driver is able to appreciate the different degrees of potential danger in the two scenarios.

FIGS. 4E and 4F illustrate a scenario in which a human subject is detected to be at least partially underneath the vehicle 101. Only the lower portion of the subject's body is inside the region 402. Similar to the scenarios shown in FIGS. 4A-4D, different alerts for the driver may be generated based on where the parts of the subject's body are detected to be.

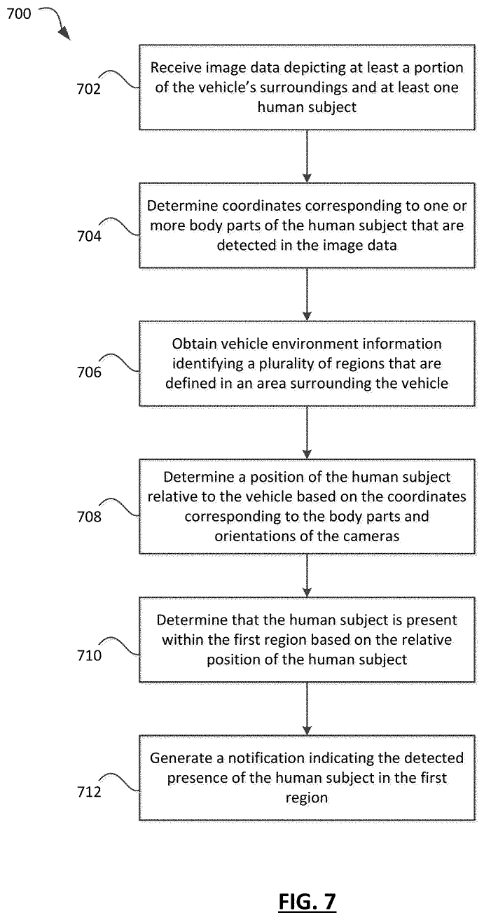

Reference is made to FIG. 7, which shows an example method 700 for detecting the presence of pedestrians in the vicinity of a vehicle, such as a school bus. The method 700 may be implemented, in conjunction, by components of a collision avoidance and/or pedestrian detection system for a vehicle, such as system 100 of FIG. 1. For example, the method 700 may be performed, at least partially, by a controller 110 (shown in FIG. 1) in conjunction with the one or more cameras 104.

In operation 702, the controller receives image data that is acquired using one or more cameras which monitor the area surrounding the vehicle. In particular, the cameras capture images of scenes that include at least parts of the vehicle's surrounding area. The image data depicts at least a portion of the vehicle's surroundings and at least one human subject. The image data may, for example, include a plurality of image frames. Upon receiving the image data, the controller may, in some embodiments, store the image data, either locally or at a remote location (e.g. cloud storage).

The captured images are analyzed to determine whether body features associated with at least one human subject are present in the images. Various known image processing and recognition techniques for human pose estimation may be employed for localizing body features in image and/or video data. Some of these known localization techniques are described in the following documents, which are incorporated herein by reference: “Articulated Human Detection with Flexible Mixtures-of-Parts” (Yi Yang and Deva Ramanan); “DeepPose: Human Pose Estimation via Deep Neural Networks” (Alexander Toshev, Christian Szegedy); “OpenPose: Realtime Multi-Person 2D Pose Estimation using Part Affinity Fields” (Zhe Cao, Gines Hidalgo, Tomas Simon, Shih-En Wei, and Yaser Sheikh); “Efficient Object Localization Using Convolutional Networks” (Jonathan Tompson, Ross Goroshin, Arjun Jain, Yann LeCun, Christoph Bregler); and “Convolutional Pose Machines” (Shih-En Wei, Varun Ramakrishna, Takeo Kanade, Yaser Sheikh).

In operation 704, the controller determines image coordinates (i.e. coordinates in image frames) that correspond to detected body features, such as the head, limbs, torso, etc. of at least one human subject. The image coordinates may be stored in a memory associated with the system. The captured images, which contain identifiable information regarding a specific human subject, may not be saved to memory; instead, only image coordinate data corresponding to the subject's body features may be stored by the system. If a human subject is not detected in the captured image, the image may be saved in memory as the most recent “reference” image, i.e. an image of the scene that does not contain a human subject. That is, rather than storing all or a plurality of images captured by the cameras, only a most recent image without any detected human subject may be maintained (i.e. stored and updated) in memory.

In operation 706, the controller obtains vehicle environment information identifying a plurality of regions that are defined in an area surrounding the vehicle. The vehicle environment information includes descriptions of regions around the vehicle which represent danger zones for pedestrians. For example, the vehicle environment information may indicate relative location, shape, and dimensions of one or more predefined regions deemed to be dangerous in a vehicle's immediate surroundings.

The controller then determines that the at least one human subject is present within a first one of the plurality of regions based on the image coordinates corresponding to the detected body parts of the human subject, which were determined in operation 704. Specifically, in operation 708, the controller determines a position of the human subject relative to the vehicle based on, at least, the image coordinates corresponding to the body parts and the orientations of the cameras that are mounted on the vehicle. That is, a position of the human subject with respect to the vehicle is determined, using information derived from the image data (i.e. image coordinates of the body features) and known information (i.e. orientations) about the cameras monitoring the vehicle's exterior. In operation 710, the controller determines that the human subject is present within the first region based on the relative position of the human subject with respect to the vehicle.

In at least some embodiments, the controller determines that a human subject is present within the first region based on determining that image coordinates for a subset of body parts are detected in the image data. That is, the controller may determine that the image coordinates corresponding to the one or more detected body parts in the image data include at least the image coordinates for a first subset of body parts. The body features which may be detected in the image data include, without limitation, left/right eye, left/right ear, nose, neck, left/right shoulder, left/right hip, left/right knee, left/right ankle, left/right elbow, and left/right wrist.

Reference is made to FIG. 5, which illustrates the viewpoint of a front-facing camera that is oriented toward the front of the vehicle 101. An image captured by the front-facing camera may depict a subset of the human subject 600's body features. In particular, only the upper body features (i.e. head, shoulders, torso) of the human subject 600 may be captured in an image from the front-facing camera. The controller may determine that the human subject 600 is occupying a danger region 602 based on detecting image coordinates corresponding to only a subset of the subject 600's body features in the image produced by the front-facing camera. As another example, referring to FIGS. 4E and 4F, the controller may determine that a human subject 600 is inside a danger region 402 based on detecting image coordinates corresponding to a subset of lower body features (e.g. leg, knees, feet, ankles) in an image produced by a side-mounted camera.

In operation 712, the controller generates a notification indicating the detected presence of the human subject in the first region. Various different types of notifications may be generated upon determining presence information, to alert the driver of different potential hazards. In some embodiments, a notification may include a graphical representation of an alert for displaying on a display device associated with the vehicle. The graphical representation may include symbols, signs, images, or any combinations thereof. The features of the graphical representations, such as size, color, etc., may be varied depending on the notification that is selected. Additionally, or alternatively, an auditory alert may be provided via onboard speakers. The features of the auditory alert, such as sound, volume, etc., may be varied depending on the notification that is selected.

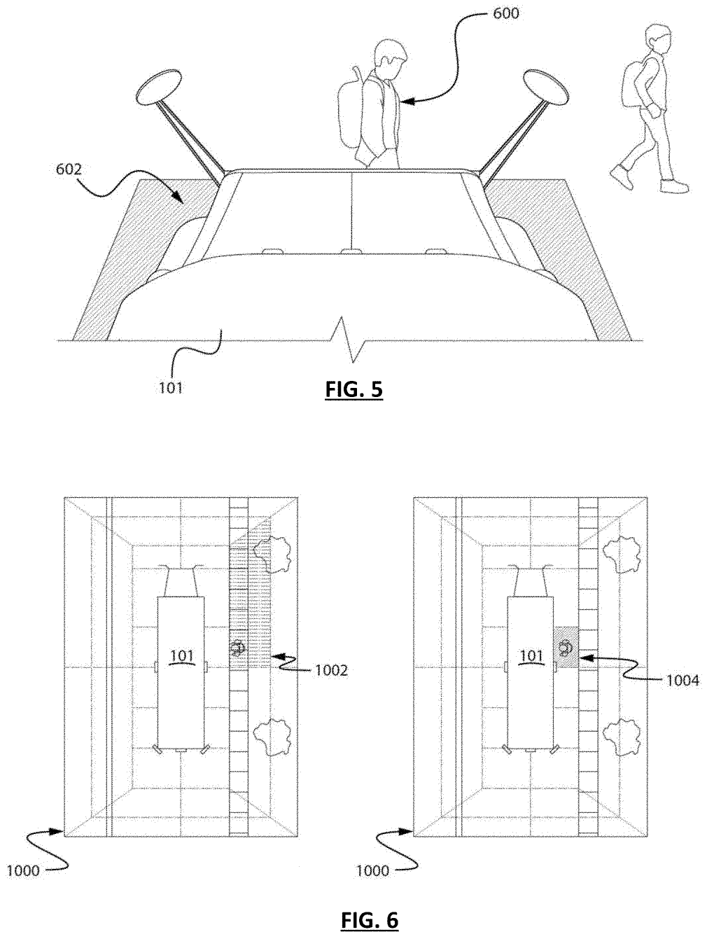

Reference is made to FIG. 6, which shows an example of a graphical representation of presence information for the vehicle 101. In at least some embodiments, a bird's eye view 1000 (or bird's eye view camera), which shows the vehicle 101 and its surrounding area, may be generated for display to a driver of the vehicle 101. A bird's eye view 1000 represents an “overhead view” of the vehicle 101. The bird's eye view 1000 may include visual representation of one or more predefined regions around the vehicle 101.

Using image stitching techniques, image data from the mounted cameras may be combined to provide the bird's eye view 1000. The bird's eye view 1000 may allow the driver to observe the locations of detected human subjects relative to the vehicle. As shown in FIG. 6, different portions of the bird's eye view 1000 may be highlighted based on where subjects are detected near the vehicle 101. That is, the bird's eye view 1000 may include graphical indications of the presence of one or more human subjects around the vehicle 101. The regions 1002 and 1004, in which human subjects are detected, may be highlighted using different colors, shapes, or textures, depending on, for example, the degree of potential hazard and/or observability for the associated regions.

The notification/alert that is generated for the driver and/or nearby persons may depend on one or more factors associated with current operating conditions of the vehicle. In this way, notifications can be selected by accounting for related vehicle operation factors in addition to presence information. In some embodiments, the selection of a notification may depend on a current gear shift position (e.g. drive, neutral, etc.) of the vehicle. For example, the controller may determine the current gear shift position of the vehicle based on sensor data obtained from a shift position sensor. The controller may then select a suitable notification based on the gear shift position. Additionally, or alternatively, the selection of a notification may depend on a current door open status of the vehicle. For example, a school bus may have a single door that is opened when loading or unloading passengers from the bus. The door open status may be determined by, for example, obtaining sensor data from a door sensor associated with the vehicle. Depending on whether the door of the vehicle is open or closed, different notifications may be generated by the system for the driver and/or nearby persons.

The controller may engage one or more additional mechanisms of the vehicle in response to determining the presence information. In some embodiments, the controller may be configured to cause a braking system associated with the vehicle to be activated upon determining that a human subject is present in the first region. That is, a braking mechanism for the vehicle may automatically be engaged, without a manual input from the driver. This may prevent the vehicle from moving when a human subject is determined to be occupying, for example, a danger zone, thereby reducing the likelihood of a collision.

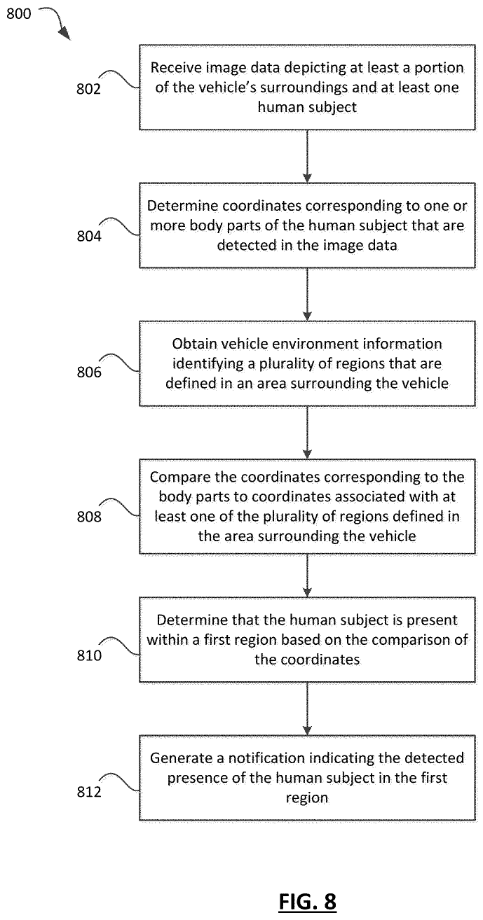

Reference is made to FIG. 8, which shows another example method 800 for detecting the presence of pedestrians in the vicinity of a vehicle, such as a school bus. The method 800 may be implemented, in conjunction, by components of a collision avoidance and/or pedestrian detection system for a vehicle, such as system 100 of FIG. 1. For example, the method 800 may be performed, at least partially, by a controller 110 (shown in FIG. 1) in conjunction with the one or more cameras 104.

Operations 802, 804 and 806 correspond to operations 702, 704 and 706, respectively, of method 700, and may be performed in a similar manner. In method 800, a different technique is employed for determining that a human subject is present in one of the regions around a vehicle. At operation 808, the controller compares the image coordinates corresponding to detected body parts of a human subject to image coordinates associated with at least one of the predefined regions in the area surrounding the vehicle. That is, rather than first determining a relative position of the human subject with respect to the vehicle, the system may compare image coordinates of the subject's body parts that are detected in the image data to image coordinates corresponding to predefined regions around the vehicle. Since the locations and orientations of the vehicle's cameras are known in advance, the coordinates corresponding to the plurality of defined regions/zones around a vehicle would also be known. For example, the image coordinates associated with boundaries of the defined regions may be predetermined and stored in memory of the system. These image coordinates may then be compared to the image coordinates of detected body features of a human subject in the image data received from the cameras.

Based on the comparisons of image coordinates, the controller may determine whether the human subject is present within a particular region, in operation 810. For example, the controller may identify a region which contains all or a subset of the subject's body features, and determine that the subject is currently occupying this region. In operation 812, the system generates a notification indicating the detected presence of the human subject in the region.

In some embodiments, the controller may be configured to determine a dirtiness of one or more of the vehicle's cameras based on analyzing image data obtained from the cameras. If it is determined that a camera is “dirty” (i.e. images from the camera include occlusions due to debris or dirt covering the lens of the camera), a suitable notification may be generated and provided to the driver (e.g. a graphical alert on a display interface of the vehicle)

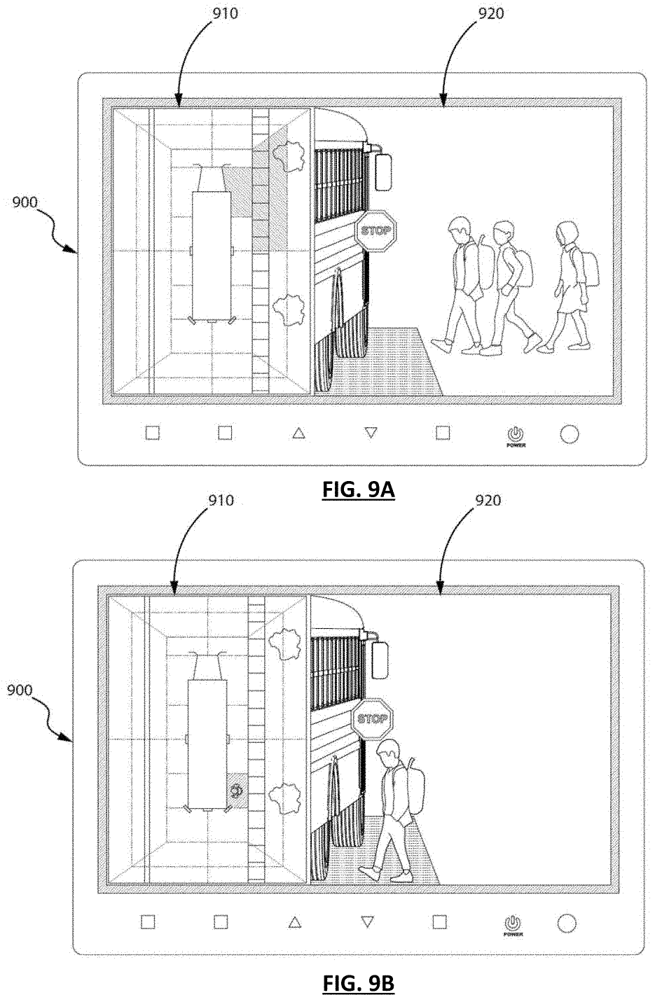

Reference is now made to FIGS. 9A and 9B, which illustrate an example graphical user interface 900 for displaying presence information for a vehicle. In at least some embodiments, the graphical user interface 900 may be subdivided into two or more different display regions. In the example of FIGS. 9A and 9B, the graphical user interface 900 contains a bird's eye view display portion 910 and a real-time video portion 920. The real-time video portion 920 presents a video feed from at least one of the cameras of the vehicle. For example, the real-time video portion 920 may display a video feed of a camera which captures image data depicting a human subject that is detected in an area around the vehicle.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A pedestrian detection system for a vehicle, comprising:
a memory;
one or more cameras for capturing images of the vehicle's surroundings, the one or more cameras being mountable on the vehicle; and
a processor coupled to the memory and the one or more cameras, the processor being configured to:
receive image data acquired using the one or more cameras, the image data depicting at least a portion of the vehicle's surroundings and at least one human subject;
determine image coordinates corresponding to one or more parts of a body of the at least one human subject that are detected in the image data;
obtain vehicle environment information for the vehicle, the vehicle environment information identifying a plurality of regions that are defined in an area surrounding the vehicle;
determine that the at least one human subject is present within a first one of the plurality of regions based on the image coordinates corresponding to the one or more detected body parts; and
generate a notification indicating the detected presence of the at least one human subject in the first region.

2. The system of claim 1, wherein the image data comprises a plurality of image frames and wherein the image coordinates comprise coordinates within an image frame.

3. The system of claim 1, wherein determining that the at least one human subject is present within the first region comprises:
determining a position of the at least one human subject relative to the vehicle based on the image coordinates corresponding to the one or more detected body parts and orientations of the one or more cameras; and
determining that the at least one human subject is present within the first region based on the position of the at least one human subject relative to the vehicle.

4. The system of claim 1, wherein determining that the at least one human subject is present within the first region comprises comparing the image coordinates corresponding to the one or more detected body parts to image coordinates associated with the first region in the image data.

5. The system of claim 1, wherein determining that the at least one human subject is present within the first region comprises determining that the image coordinates corresponding to the one or more detected body parts include at least the image coordinates for a first subset of body parts.

6. The system of claim 1, wherein generating the notification comprises generating a graphical representation of an alert for displaying on a display device associated with the vehicle.

7. The system of claim 1, wherein generating the notification comprises:
determining at least one of a gear shift position of the vehicle or a door open status of the vehicle; and
selecting a notification based on the at least one of a gear shift position of the vehicle or a door open status of the vehicle.

8. The system of claim 1, wherein the processor is further configured to generate a visual representation of at least one of the plurality of regions for displaying on a display device associated with the vehicle.

9. The system of claim 8, wherein the processor is further configured to provide an indication of the presence of the at least one human subject in the visual representation of the at least one of the plurality of regions.

10. The system of claim 1, wherein the processor is further configured to cause a braking system associated with the vehicle to be activated in response to determining that the at least one human subject is present in the first region.

11. A method for detecting pedestrians in a vicinity of a vehicle, the method comprising:
receiving image data acquired using one or more cameras, the image data depicting at least a portion of the vehicle's surroundings and at least one human subject;
determining image coordinates corresponding to one or more parts of a body of the at least one human subject that are detected in the image data;
obtaining vehicle environment information for the vehicle, the vehicle environment information identifying a plurality of regions that are defined in an area surrounding the vehicle;
determining that the at least one human subject is present within a first one of the plurality of regions based on the image coordinates corresponding to the one or more detected body parts; and
generating a notification indicating the detected presence of the at least one human subject in the first region.

12. The method of claim 11, wherein the image data comprises a plurality of image frames and wherein the image coordinates comprise coordinates within an image frame.

13. The method of claim 11, wherein determining that the at least one human subject is present within the first region comprises:
determining a position of the at least one human subject relative to the vehicle based on the image coordinates corresponding to the one or more detected body parts and orientations of the one or more cameras; and
determining that the at least one human subject is present within the first region based on the position of the at least one human subject relative to the vehicle.

14. The method of claim 11, wherein determining that the at least one human subject is present within the first region comprises comparing the image coordinates corresponding to the one or more detected body parts to image coordinates associated with the first region in the image data.

15. The method of claim 11, wherein determining that the at least one human subject is present within the first region comprises determining that the image coordinates corresponding to the one or more detected body parts include at least the image coordinates for a first subset of body parts.

16. The method of claim 11, wherein generating the notification comprises generating a graphical representation of an alert for displaying on a display device associated with the vehicle.

17. The method of claim 11, wherein generating the notification comprises:
determining at least one of a gear shift position of the vehicle or a door open status of the vehicle; and
selecting a notification based on the at least one of a gear shift position of the vehicle or a door open status of the vehicle.

18. The method of claim 11, wherein the processor is further configured to generate a visual representation of at least one of the plurality of regions for displaying on a display device associated with the vehicle.

19. The method of claim 18, wherein the processor is further configured to provide an indication of the presence of the at least one human subject in the visual representation of the at least one of the plurality of regions.

20. The method of claim 11, wherein the processor is further configured to cause a braking system associated with the vehicle to be activated in response to determining that the at least one human subject is present in the first region.
